(19) United States
(12) Patent Application Publication
(10) Pub. No.: US 2009/0181673 A1
(43) Pub. Date: Jul. 16, 2009

(54) METHOD, APPARATUS AND BASE STATION FOR DETERMINING A RADIO LINK CHARACTERISTIC

(75) Inventor: Stephen J. Barrett, West Berkshire (GB)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/575,822

(22) PCT Filed: Oct. 31, 2005
(86) PCT No.: PCT/US05/39228

§ 371 Date: Mar. 22, 2007

(30) Foreign Application Priority Data
Dec. 6, 2004 (GB) 0426697.9

(51) Int. Cl. H04W 36/00

(52) U.S. Cl. 455/436

(57) ABSTRACT

A cellular communication system supports both soft handover communication channels and non-soft handover communication channels from the same user equipment (101). A serving base station (103) comprises a receive front end (201) for receiving transmissions from the user equipment (101). A first indication processor (203) receives a first link quality indication associated with a first signal of a soft handover communication channel from the user equipment (101). A second indication processor 205 receives a second link quality indication associated with a second signal of a non-soft handover channel from the user equipment (101). A characteristic processor (207) then determines the radio link characteristic in response to the first and second link quality indications. For example a power control command for a soft handover signal and a channel quality indicator for a non-soft handover signal may be compared and a radio link quality may be determined in response to the comparison.

### FIELD OF THE INVENTION

The invention relates to a method, apparatus and base station for determining a radio link characteristic and in particular, but not exclusively, for determining a radio link characteristic in a 3^{rd} Generation cellular communication system.

### BACKGROUND OF THE INVENTION

In a cellular communication system, a geographical region is divided into a number of cells served by base stations. The base stations are interconnected by a fixed network which can communicate data between the base stations. A mobile station is served via a radio communication link from the base station of the cell within which the mobile station is situated.

A typical cellular communication system extends coverage over an entire country and comprises hundreds or even thousands of cells supporting thousands or even millions of mobile stations. Communication from a mobile station to a base station is known as the uplink, and communication from a base station to a mobile station is known as the downlink.

The fixed network interconnecting the base stations is operable to route data between any two base stations, thereby enabling a mobile station in a cell to communicate with a mobile station in any other cell. In addition, the fixed network comprises gateway functions for interconnecting to external networks such as the Internet or the Public Switched Telephone Network (PSTN), thereby allowing mobile stations to communicate with landline telephones and other communication terminals connected by a landline. Furthermore, the fixed network comprises much of the functionality required for managing a conventional cellular communication network including functionality for routing data, admission control, resource allocation, subscriber billing, mobile station authentication etc.

The most ubiquitous cellular communication system is the 2nd generation communication system known as the Global System for Mobile communication (GSM). GSM uses a technology known as Time Division Multiple Access (TDMA) wherein user separation is achieved by dividing frequency carriers into 8 discrete time slots, which individually can be allocated to a user. Further description of the GSM TDMA communication system can be found in ‘The GSM System for Mobile Communications’ by Michel Mouly and Marie Bernadette Pautet, Bay Foreign Language Books, 1992, ISBN 2950719007.

Currently, 3rd generation systems are being rolled out to further enhance the communication services provided to mobile users. The most widely adopted 3rd generation communication systems are based on Code Division Multiple Access (CDMA) technology. Both Frequency Division Duplex (FDD) and Time Division Duplex (TDD) techniques employ this CDMA technology. In CDMA systems, user separation is obtained by allocating different spreading and scrambling codes to different users on the same carrier frequency and in the same time intervals. In TDD, additional user separation is achieved by assigning different time slots to different users in a similar way to TDMA. However, in contrast to TDMA, TDD provides for the same carrier frequency to be used for both uplink and downlink transmissions. An example of a communication system using this principle is the Universal Mobile Telecommunication System (UMTS). Further description of CDMA and specifically of the Wideband CDMA (WCDMA) mode of UMTS can be found in ‘WCDMA for UMTS’, Harri Holma (editor), Antti Toskala (Editor), Wiley & Sons, 2001, ISBN 0471486876.

In a 3rd generation cellular communication system, the communication network comprises a core network and a Radio Access Network (RAN). The core network is operable to route data from one part of the RAN to another, as well as interfacing with other communication systems. In addition, it performs many of the operation and management functions of a cellular communication system, such as billing. The RAN is operable to support wireless user equipment over a radio link of the air interface. The RAN comprises the base stations, which in UMTS are known as Node Bs, as well as Radio Network Controllers (RNC) which control the base stations and the communication over the air interface.

The RNC performs many of the control functions related to the air interface including radio resource management and routing of data to and from appropriate base stations. It further provides the interface between the RAN and the core network. An RNC and associated base stations are collectively known as a Radio Network Subsystem (RNS).

3rd generation cellular communication systems have been specified to provide a large number of different services including efficient packet data services. For example, downlink packet data services are supported within the 3GPP release 5 specifications in the form of the High Speed Downlink Packet Access (HSDPA) service.

In accordance with the 3GPP specifications, the HSDPA service may be used in both Frequency Division Duplex (FDD) mode and Time Division Duplex (TDD) mode.

In UMTS systems that support HSDPA, transmission code resources are managed in both the RNC and the Node B. The base station (also known as the Node-B for UMTS) is responsible for allocating and distributing the shared HSDPA code resources to the users who have an HS-DSCH assigned. The RNC is responsible for allocating code resources to Dedicated CHannels (DCH's) and other common channels. Hence, in UMTS systems that support HSDPA, some code resource allocation is performed by the RNC whereas other code resource scheduling is performed by the base station. Specifically, the RNC allocates a set of resources to each base station, which the base station can use exclusively for high speed packet services. The base station is responsible for scheduling transmissions on the HS-DSCH to the mobile stations that are attached to it, for operating a retransmission scheme, for controlling the coding and modulation of HS-DSCH transmissions to the mobile stations and for transmitting data packets to the mobile stations.

HSDPA seeks to provide packet access techniques with a relatively low resource usage and with low latency.

Specifically, HSDPA uses a number of techniques in order to reduce the resource required to communicate data and to increase the capacity of the communication system. These techniques include Adaptive Coding and Modulation (AMC), retransmission with soft combining and fast scheduling performed at the base station.

Although 3^{rd} Generation cellular communication systems support soft handover wherein transmissions between a mobile station and a plurality of base stations are combined for improved performance, HSDPA is designed for only a single cell. Accordingly, HSDPA relies on only a single radio link and soft handover of HSDPA signals is not supported. Thus, in an HSDPA enabled cellular communication system some communication channels may support soft handover whereas other communication channels (such as HSDPA channels) do not.

In an HSDPA system, the mobile station transmits a Channel Quality Indicator (CQI) command to the base station. The CQI is determined by the mobile station by measuring a pilot signal transmitted from the base station supporting the HSDPA call. In addition, the mobile station transmits a power control command which is an instruction to base stations in the active set to either increase or decrease the transmit power. The power control command is determined by the mobile station by measuring the received quality of a dedicated soft handover channel.

In existing communication systems, the power control command is used by base stations of the active set to control their transmit power and the CQI command is used by the base station scheduler to schedule data to HSDPA channels which are currently experiencing advantageous propagation conditions.

However, although this approach provides acceptable performance in many situations, it is not optimal for all conditions. In particular, the conventional approach does not fully exploit the received information for optimally determining a characteristic of a radio link in order to customise the operation for the current conditions.

Hence, an improved system for determining a radio link characteristic would be advantageous and in particular a system allowing increased flexibility, improved and/or additional information, increased accuracy and/or increased performance of the communication system would be advantageous.

### SUMMARY OF THE INVENTION

Accordingly, the Invention seeks to preferably mitigate, alleviate or eliminate one or more of the above mentioned disadvantages singly or in any combination.

According to a first aspect of the invention there is provided an apparatus for determining a radio link characteristic of a radio link between a base station and a user equipment in a cellular communication system, the apparatus comprising: means for receiving a first link quality indication associated with a first signal of a soft handover communication channel from the user equipment; means for receiving a second link quality indication associated with a second signal of a non-soft handover channel from the user equipment; and means for determining the radio link characteristic in response to the first and second link quality indications.

The invention may allow for an improved performance in a cellular communication system. Additional, enhanced and/or more accurate information for a radio link may be provided. The information of the radio link characteristic may be used to improve performance for the current conditions, thereby improving performance of the communication system as a whole.

The soft handover communication channel may be a logical communication channel allowing soft handover of the first signal. The non-soft handover communication channel may be a logical communication channel for which soft handover may not be used. For example, the technical specifications for the cellular communication system may define some logical channels for which soft handover is allowed and some logical channels for which soft handover is not allowed.

The user equipment may be a communication unit, a User Equipment (UE) of a 3^{rd} Generation cellular communication system, a subscriber unit, a remote unit, a mobile station, a communication terminal, a personal digital assistant, a laptop computer, an embedded communication processor or any physical, functional or logical communication element which is capable of communicating over the air interface of the cellular communication system.

According to an optional feature of the invention, the radio link is a radio link supporting the non-soft handover channel. The radio link may be a radio link used for transmission of the first signal. The invention may allow improved information for the radio link supporting the non-soft handover channel to be determined thereby allowing improved performance.

According to an optional feature of the invention, the means for determining the radio link characteristic is operable to determine the radio link characteristic in response to a correlation between the first link quality indication and the second link quality indication. The correlation may be any indication of a similarity or correspondence or commonality between the first and second link quality indications. In particular, the invention may provide information of a radio characteristic by comparing a first link quality indication associated with a first signal of a soft handover communication channel to a second link quality indication associated with a second signal of a non-soft handover channel.

According to an optional feature of the invention, the radio link characteristic is a radio quality characteristic and the means for determining the radio link characteristic is operable to determine an increasing radio link quality for an increasing correlation. In particular, a high radio link quality of the radio link supporting the non-soft handover communication channel may be determined if the radio link quality indications of the non-soft handover and the soft handover communication channels are similar. The similarity between the first and second link quality indication is typically indicative of the radio link between the base station and the user equipment being a significant contributor to the soft handover communication and thus indicates that this radio link has a high quality. The radio link quality may in particular be a relative quality indicative of the relative quality of the radio link supporting the non-soft handover communication channel in comparison to radio links supporting the soft handover communication channels.

According to an optional feature of the invention, the means for determining the radio link characteristic is operable to determine the correlation in response to a variation of the first link quality indication in comparison to a variation of the second link quality indication.

This may provide a practical and low complexity implementation resulting in accurate results. The radio link characteristic may for example be determined in response to a trend of the first and second link quality indications and/or may be determined in response to a correlation of variations between the first and the second link quality indication in a given time interval.

According to an optional feature of the invention, the apparatus further comprises means for determining a relative quality of the radio link relative to other radio links supporting the soft handover communication channel. The first and second link quality indications may specifically be used to determine the quality of the radio link supporting the non-handover communication channel relative to other radio links supporting the soft-handover communication channel and in particular a high correlation between the first and second link quality indicators may be indicative of the soft-handover communication channel being dominated by the radio link supporting the non-soft handover communication channel. Conversely, a low correlation may indicate that the soft-handover communication channel is dominated by other radio links and that accordingly the radio quality of the radio link supporting the non-soft handover communication link is relatively low.

According to an optional feature of the invention, the apparatus further comprises means for predicting a handover of the second signal in response to the relative quality. The invention may allow an improved detection of a handover which is likely to occur. This detection may be independent of any other characteristics and may in particular be independent of handover algorithms. This feature may for example allow a base station to determine that a handover is likely to occur independently of a network controller in which the handover decision is made.

According to an optional feature of the invention, the means for predicting the handover is operable to predict the handover if the relative quality is indicative of a quality of the radio link being lower than a quality of at least one radio link of the radio links supporting the soft handover communication channel. Typically, a low quality of a radio link of a serving base station in comparison to radio links of a soft handover from non-serving base stations is indicative of a preference for a handover. The feature may thus provide an improved detection of a handover situation occurring.

According to an optional feature of the invention, the apparatus comprises means for reducing a buffer loading associated with the second signal in response to a prediction of a handover. In some embodiments, the apparatus may for example cause a scheduler to schedule an increasing data amount for communications supported by radio links likely to be handed over. This may reduce disruptions at handovers and may improve the provided quality of service. This may be particularly advantageous for streaming services and may specifically reduce delay variations when the service is handed over between base stations.

According to an optional feature of the invention, the apparatus comprises a scheduler which is operable to schedule data for the second signal only if no handover is predicted. In some embodiments, the apparatus may stop transmitting data using radio links which are likely to be handed over thereby delaying these transmissions until after handover when the transmissions may be made more effectively. This may reduce resource consumption and improve system performance and may typically be particularly advantageous for background or interactive services where delay is less important.

According to an optional feature of the invention, the apparatus further comprises means for instigating a handover of the second signal in response to the relative quality. The invention may provide handover determination and may in particular provide additional, alternative and/or improved information that allows an improved detection of when a handover should be performed.

According to an optional feature of the invention, the means for instigating the handover is operable to instigate the handover if the relative quality is indicative of a quality of the radio link being lower than a quality of at least one radio link of the radio links supporting the soft handover communication channel. This may provide a good indication of the occurrence of conditions wherein a handover may be advantageous. The feature may allow for improved handover performance in a cellular communication system.

According to an optional feature of the invention, the apparatus further comprises a scheduler for scheduling data for the non-soft handover communication channel in response to the radio link quality. This may provide improved data scheduling and may in particular allow a more efficient utilisation of the available communication resources.

According to an optional feature of the invention, the scheduler is furthermore operable to schedule data for the non-soft handover communication channel in response to a quality of service requirement. This may improve performance and may for example provide for an efficient scheduling while ensuring a required quality of service.

According to an optional feature of the invention, the first link quality indication is a power control command. The transmit power control command may specifically be an indication transmitted from the user equipment to the base station(s) and indicating whether base station transmit power(s) should be increased or decreased. This is a particularly suitable parameter which is typically communicated for other purposes in a cellular communication system.

According to an optional feature of the invention, the cellular communication system is a 3^{rd} Generation cellular communication system and the second signal may specifically be an HSDPA signal. The invention may in some embodiments provide improved performance in a 3^{rd} Generation cellular communication system and may in particular provide improved performance in a 3^{rd} Generation cellular communication system employing HSDPA by using existing information reported for other purposes. The 3^{rd} Generation cellular communication system may for example be a UMTS cellular communication system in accordance with the specifications of the 3^{rd} Generation Partnership Project (3GPP).

According to an optional feature of the invention, the second link quality indication is a Channel Quality Indication (CQI) command. This is a particularly suitable parameter which is typically communicated for other purposes in a cellular communication system employing HSDPA services.

According to a second aspect of the invention, there is provided a cellular communication system comprising a base station and a user equipment in a cellular communication system, the cellular communication system further comprising: means for receiving from the user equipment, a first link quality indication associated with a first signal of a soft handover communication channel between the base station and the user equipment; means for receiving from the user equipment, a second link quality indication associated with a second signal of a non-soft handover channel between the base station and the user equipment; and means for determining a radio link characteristic of a radio link between the base station and the user equipment in response to the first and second link quality indications.

According to a second aspect of the invention, there is provided a method of determining a radio link characteristic of a radio link between a base station and a user equipment in a cellular communication system, the method comprising: receiving a first link quality indication associated with a first signal of a soft handover communication channel from the user equipment; receiving a second link quality indication associated with a second signal of a non-soft handover channel from the user equipment; and determining the radio link characteristic in response to the first and second link quality indications.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a cellular communication system incorporating some embodiments of the invention; and

FIG. 2 illustrates an example of a base station in accordance with some embodiments of the invention.

### DETAILED DESCRIPTION OF EMBODIMENTS OF THE INVENTION

The following description focuses on embodiments of the invention applicable to a 3^{rd} Generation cellular communication system and in particular to 3^{rd} Generation cellular communication system supporting HSDPA services. However, it will be appreciated that the invention is not limited to this application but may be applied to many other communication systems and services.

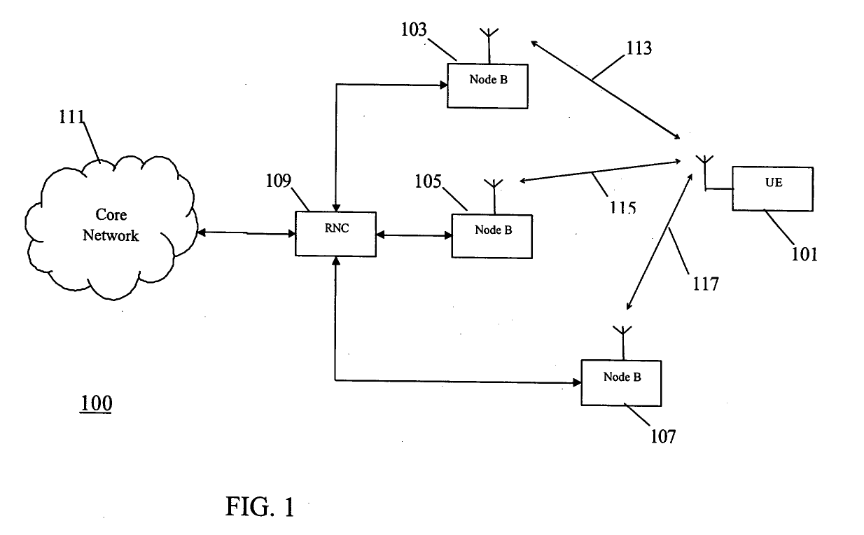

FIG. 1 is an illustration of a UMTS cellular communication system 100 incorporating some embodiments of the invention.

In the example of FIG. 1, a user equipment 101 is supported by three base stations (node Bs) 103, 105, 107. The three base stations 103-107 are coupled to a Radio Network Controller (RNC) 109 which is coupled to a core network 111 as is typical for UMTS cellular communication systems as will be well known to the person skilled in the art. In the example of FIG. 1, the user equipment 101 is in an overlap area between three different cells supported by the three different base stations 103-107. It will be appreciated that although each cell of the current example is supported by a separate base station, individual base stations may in other examples support more than one cell.

In the current example, the user equipment 101 is communicating with a serving base station 103 through a first radio link 113 but is also communicating with two other base stations 105, 107 over other radio links 115, 117. Specifically, the user equipment 101 is currently in a soft handover configuration with an active set comprising the three base stations 103-107.

For clarity and brevity, FIG. 1 illustrates only aspects of the communication system required to describe exemplary embodiments of the invention. Similarly, only the functionality and features required to describe the embodiments will be described and it will be apparent to the person skilled in the art that the illustrated elements will be capable of performing other functions and provide features required or desired for the operation of 3^{rd} Generation cellular communication system as appropriate.

In the example of FIG. 3, the user equipment 101 is currently involved in an HSDPA call supported by a first of the base stations 103. Thus, the user equipment 101 is communicating with the first base station using HSDPA communication channels. In particular, the first serving base station 103 is transmitting data to the user equipment 101 on an HS-DSCH (High Speed—Downlink Shared CHannel) channel. Similarly, an uplink HS-DPCCH (High Speed Dedicated Physical Control CHannel) channel has been setup to communicate control data from the user equipment 101 to the base station 103 as known from conventional HSDPA systems. The HSDPA channels cannot be involved in soft handovers but are dedicated communication links between the user equipment 101 and the serving base station 103. This facilitates operation for HSDPA services, and for example allows that a fast and individual resource allocation for HSDPA services can be performed by the individual base station 103 in response to current fluctuations of the radio link 113 between the base station 103 and the user equipment 101.

The HS-DPCCH is used to transmit various control messages including Hybrid ARQ ACK/NACK and CQI (Channel Quality Indicator) data. The Hybrid ARQ ACK/NACK data comprises acknowledge data used by the Hybrid ARQ retransmission scheme of the HSDPA service whereas the CQI commands are indicative of a quality of the radio link 113 between the serving base station 103 and the user equipment 101. The user equipment 101 measures the current receive quality of a pilot signal of the base station 103 and reports the result by transmitting the CQI commands. Thus, the CQI commands are indicative of the current radio propagation conditions from the base station 103 to the user equipment 101 and are used by the scheduling function of the base station 103 to schedule HSDPA data on the shared HS-DSCH to user equipment experiencing advantageous conditions. Such link adaptation scheduling may result in a substantially improved efficiency of the resource usage and may increase the capacity of the cellular communication system as a whole.

Furthermore, a number of non-HSDPA communication channels are currently set up for the user equipment 101 in the specific example of FIG. 1. Specifically, the user equipment 101 is supporting a DPCCH (Dedicated Physical Control CHannel) which is used to transmit various control data and commands from the user equipment 101 to the fixed network. A DPDCH (Dedicated Physical Data CHannel) may also be set up between UE and the fixed network for the purposes of carrying data and/or signalling information. The user equipment 101 also receives transmission from the base stations on non-HSDPA channels. For example, the user equipment 101 will receive a DPCCH and may additionally receive a DPDCH.

The non-HSDPA communication channels are in the specific example in a soft handover state. Thus, a plurality of base stations 101-103 receive the uplink transmissions from the user equipment 101 and the uplink signals received at the individual base stations are combined (for example by selection combining). Similarly, the plurality of base stations 101-103 all transmit the same data to the user equipment 101 in the same time intervals and the user equipment 101 combines the received signals to determine the received data. Thus, in the example of FIG. 1, the user equipment 101 is in a configuration wherein it is simultaneously supporting HSDPA channels, which are not allowed to be in a soft handover, and non-HSDPA channels which are in a soft handover.

The transmit powers of the plurality of base stations 103-107 are controlled by a power control loop which relies on data fed back from the user equipment 101 to the base stations 103-107. The user equipment 101 determines a quality level of the received signal and if this quality is above a threshold a power down command is transmitted to the base stations, and if the quality is below the threshold a power up command is transmitted to the base stations. Specifically, the user equipment 101 transmits Transmit Power Commands (TPCs) on the DPCCH to the base stations 101-103. Each individual base station operates a power control loop resulting in an increase of the transmit power in response to power up TPCs and a reduction of the transmit power in response to power down TPCs.

Thus, when the user equipment 101 is in a soft handover state, it reports both TPC commands which relate to soft handover channels and CQI commands which relate to non-soft handover channels. Conventionally, these commands are individually used for different purposes. However, in accordance with some embodiments of the current invention, the TPC and CQI commands are used together to determine characteristics of a radio link. In particular, the TPC and CQI reports are compared to each other and the radio link characteristic is determined in response to the correlation between the received data.

In accordance with some embodiments of the current invention, a base station may in an HSDPA system receive two indications of the downlink quality on the radio link 113 between the user equipment 101 and the base station 103 from which HS-DSCH is transmitted. The base station receives an inner loop power control command (TPC) sent on the DPCCH and an HSDPA quality indicator command (CQI) which is sent on the HS-DPCCH. However, rather than merely using these indicators for their conventional purposes, the two quality indicators are considered together in order to derive additional or improved information of the quality of a radio link and specifically of the radio link 113 from the serving base station 103.

For example, if the commands are consistently contradictory this may be taken as an indication that another cell in the active set is currently the best cell. In other words one of the radio links in the active set on which the HS-DSCH is not being transmitted may currently experience the best radio conditions and hence is effectively currently controlling the inner power control loop. Thus, by comparing a quality indicator relating to a non-soft handover channel to a soft handover channel, an indication of the current radio link characteristics may be obtained. Accordingly, information which is typically not available at the base station 103 may be generated allowing e.g. an improved scheduling and thus capacity increase or an improved quality of service.

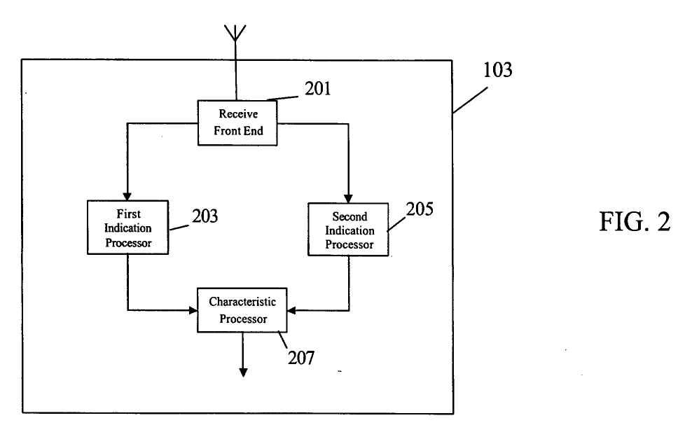

FIG. 2 illustrates an example of the base station 103 in accordance with some embodiments of the invention. For brevity and clarity, only the elements of the base station 103 necessary for describing the exemplary embodiments are shown and will be described.

The base station 103 comprises a receiver front end 201 which is operable to receive transmissions from the user equipment 101 and to filter, amplify, down-convert, and decode the received signal to regenerate the transmitted data as is known to the person skilled in the art. The receiver front end 201 is specifically operable to generate the received data for the HS-DPCCH and for the DPCCH communication channels.

The receiver front end 201 is coupled to a first indication processor 203 and a second indication processor 205. The receiver front end 201 feeds the data of the DPCCH to the first indication processor 203 and the data of the HS-DPCCH to the second indication processor 205. In response, the first indication processor 203 extracts the power control commands TPCs and the second indication processor 205 extracts the CQI data. Thus, the first indication processor 203 generates a first link quality indication, in the form of TPCs, which is associated with a signal of a soft handover communication channel, in the form of the DPCCH. Similarly, the second indication processor 205 generates a second link quality indication, in the form of CQIs, which is associated with a signal of a communication channel which cannot be in a soft handover, in the form of the HS-DPCCH.

The first indication processor 203 and the second indication processor 205 are coupled to a characteristic processor 207 which determines a radio link characteristic in response to the first and second link quality indications, i.e. in response to the TPC and CQI indications.

In particular, the characteristic processor 207 determines how closely correlated the TPC and CQI data is and determines a radio link characteristic in response to the correlation. Any correlation indicative of a similarity, correspondence or commonality between the link quality indicators may be used.

As a specific example, the characteristic processor 207 may look at TPCs and CQIs received within a given time interval and may determine if the variations of the TPC and CQIs are similar.

For example, the received TPCs may in an initial part of the interval comprise a majority of power up commands, in a second part comprise a majority of power down commands and in a third interval may have a substantially equal amount of power up and power down commands. In this case, if the CQIs are predominantly indicative of a poor quality in the first interval, of a high quality in the second interval and substantially equally of a high or low quality in the third interval, the quality indicators may be considered to be highly correlated. However, if the CQIs e.g. indicate a low quality for all three intervals, the correlation may be considered low.

As another example, each power up TPC may be allocated a value of −1 and each power down TPC may be allocated a value of 1 and the resulting values may be filtered in a low pass filter having a suitable time constant. Similarly, each CQI indicative of a high quality may be assigned a value of 1 and each CQI indicative of a low quality may be assigned a value of −1 and the result may be low pass filtered. A measure of the correlation between the two signal indicators may then be determined as the difference between the low pass filter outputs.

The correlation may in particular provide a good indication of the quality of the radio link 113 of the serving base station 103 relative to the quality of the radio links 115, 117 of the other base stations 105, 107. Specifically, if the correlation is high, this is an indication that the characteristics of the single radio link 113 is similar to the characteristics of the combined effect of all the soft handover radio links 113, 115, 117 and thus an indication that the radio link 113 of the serving base station 103 is the dominant link of the soft handover. This indicates that the quality level of the radio link from the serving base station 103 is high. In contrast, if the correlation is low, this is indicative of another link (or links) being dominant in the soft handover and thus of the link 113 from the serving base station 103 being low.

Hence, in some embodiments, a radio link quality of the radio link 113 from the serving base station 103 may be determined such that an increasing correlation corresponds to an increasing quality level of the radio link 113 of the serving base station 103. In particular, the quality level of the radio link 113 of the serving base station 103 in comparison to the radio links 115, 117 to the other base stations 105, 107 supporting the handover may be determined in response to the correlation.

The characteristic processor 207 may thus determine a radio link characteristic for the radio link 113 of the serving base station 103 and may in particular determine a radio link quality of the radio link 113. The radio link characteristic may be used for different purposes in different embodiments.

For example, in some embodiments, the radio link characteristic may be used to detect that a handover is likely to occur. Specifically, if the correlation between the radio link quality indicator (TPCs) of the soft handover signals and the radio link quality indicator (CQI) of the non-handover signal is low, this is indicative of a situation where at least one other radio link than the link from the serving base station currently experiences better propagation conditions. Accordingly, if this condition persists, the communication system will at some stage perform a handover of the HS-DSCH to the cell having the best radio link quality.

In typical 3^{rd} generation systems, the handover decision is made at the RNC 109 without the base stations having any prior knowledge of the decision. However, in accordance with some embodiments of the current invention, the base station 103 may predict that a handover is likely to occur based on locally received signals. Thus, the base station 103 may predict the handover and may accordingly optimise operation for the likely handover independently of the operation of the RNC.

Specifically, for e.g. streaming services, the serving base station 103 may seek to schedule more data for radio links which are likely to be handed over in order to reduce the buffer loading for these links. Thus, the base station 103 may effectively seek to flush the buffer in preparation for a handover thereby reducing the disruption and the amount of lost data. In some systems, such as HSDPA, any lost data during a handover is detected by the retransmission scheme and is retransmitted from the new base station. However, this increases the disruption and delay of a handover and may result in e.g. noticeable disruptions in a streaming service. Accordingly, a reduced delay and improved quality of service may be achieved by the prediction of a handover at the base station.

In some embodiments, it may be advantageous to stop scheduling data if a likely handover situation is detected. For example, an HSDPA scheduler of a base station may be arranged to only schedule data if no handover is predicted.

This may for example be advantageous in background or interactive services wherein delays or disruptions are not important and may allow that data is not scheduled when the radio link conditions are likely to be substantially improved by being handed over to a different base station experiencing superior propagation conditions. This may typically improve the performance of the communication system as a whole and may provide for a more efficient resource utilisation.

In some embodiments, the radio link characteristic may also be used to instigate a handover. For example, if the correlation determined by the characteristic processor 207 is below a given threshold for a given length of time, this is indicative of the current serving base station 103 being less optimal than another base station 105, 107 and accordingly a handover instigation command may be generated and transmitted to the RNC 109. The RNC 109 may in response activate the handover algorithm to determine if a handover is feasible and if so a handover command is sent to the user equipment 101 and the base stations 101-103.

In some embodiments, the cellular communication system may comprise a scheduler for scheduling data for the non-soft handover communication channel in response to the radio link quality determined by the characteristic processor 207. In particular, the HSDPA scheduler of the base station 103 may include the correlation between the TPCs and the CQIs as an input parameter for the scheduling algorithm.

For example, the information may be used at a time granularity in the order of the fading rate for the propagation channel such that data packets are preferentially scheduled when the correlation indicates that the serving base station 103 corresponds to the best cell in the active set. Typically, if another cell is consistently better than the current serving cell, a handover of the HS-DSCH will typically be invoked after a few seconds. However, an advantage of the fast scheduling system is that during this delay, the scheduler will not have expended excessive power by scheduling the data for transmission.

In some embodiments, the scheduler furthermore takes a quality of service requirement into account. For example, although the correlation may indicate that the current radio link is not the optimal radio link and that a handover may be imminent, data may still be scheduled if this is required to meet a given delay requirement for the service. Thus, improved system efficiency may be achieved while ensuring that the minimum service requirements are still met.

It will be appreciated that the above description for clarity has described embodiments of the invention with reference to different functional units and processors. However, it will be apparent that any suitable distribution of functionality between different functional units or processors may be used without detracting from the invention. For example, functionality illustrated to be performed by separate processors or controllers may be performed by the same processor or controllers. Hence, references to specific functional units are only to be seen as references to suitable means for providing the described functionality rather than indicative of a strict logical or physical structure or organization.

The invention can be implemented in any suitable form including use of hardware, software, firmware or any combination of these. The invention may optionally be implemented partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality.

1. An apparatus for determining a radio link characteristic of a radio link between a base station and a user equipment in a cellular communication system, the apparatus comprising:
means for receiving a first link quality indication associated with a first signal of a soft handover communication channel from the user equipment;
means for receiving a second link quality indication associated with a second signal of a non-soft handover channel from the user equipment; and
means for determining the radio link characteristic in response to the first and second link quality indications.

2. The apparatus claimed in claim 1 wherein the radio link is a radio link supporting the non-soft handover channel.

3. The apparatus claimed in claim 1 wherein the means for determining the radio link characteristic is operable to determine the radio link characteristic in response to a correlation between the first link quality indication and the second link quality indication.

4. The apparatus claimed in claim 3 wherein the radio link characteristic is a radio quality characteristic and the means for determining the radio link characteristic is operable to determine an increasing radio link quality for an increasing correlation.

5. The apparatus claimed in claim 3 wherein the means for determining the radio link characteristic is operable to determine the correlation in response to a variation of the first link quality indication in comparison to a variation of the second link quality indication.

6. The apparatus claimed in claim 1 further comprising means for determining a relative quality of the radio link relative to other radio links supporting the soft handover communication channel.

7. The apparatus claimed in claim 6 further comprising means for predicting a handover of the second signal in response to the relative quality.

8. The apparatus claimed in claim 7 wherein the means for predicting the likely handover is operable to detect that a handover is likely if the relative quality is indicative of a quality of the radio link being lower than a quality of at least one radio link of the radio links supporting the soft handover communication channel.

9. The apparatus claimed in claim 7 wherein the apparatus comprises means for reducing a buffer loading associated with the second signal in response to a prediction of a handover.

10. The apparatus claimed in claim 7 wherein the apparatus comprises a scheduler which is operable to schedule data for the second signal only if no handover is predicted.
